(19) United States
(12) Patent Application Publication
(10) Pub. No.: US 2007/0046561 A1
(43) Pub. Date: Mar. 1, 2007

(54) MOBILE COMMUNICATION TERMINAL FOR DISPLAYING INFORMATION

(75) Inventors: Jee Young Cheon, Daegu-si (KR); Yeon Woo Park, Seoul-si (KR); Sang Hyuck Lee, Seoul-si (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG Electronics Inc.

(21) Appl. No.: 11/466,732

(22) Filed: Aug. 23, 2006

(30) Foreign Application Priority Data
Aug. 23, 2005 (KR) 10-2005-0077419
Oct. 17, 2005 (KR) 10-2005-0097484
Dec. 30, 2005 (KR) 10-2005-0135018

(51) Int. Cl. G09G 5/00

(52) U.S. Cl. 345/1.1

(57) ABSTRACT

The present invention is related to a mobile communication terminal capable of displaying information. The mobile communication includes a first display unit, a second display unit, a memory unit for storing displayable main information, and a control unit for controlling first sub-information of the main information displayable on the first display unit and controlling second sub-information of the main information displayable on the second display unit, wherein the first sub-information and the second sub-information are continually varied and correlated to each other for providing continuity of information between the first display unit and the second display unit.

### CROSS-REFERENCE TO RELATED APPLICATIONS

This application claims the benefit of the Korean Patent Application Nos. 10-2005-0077419, filed on Aug. 23, 2005, 10-2005-0097484 filed on Oct. 17, 2005, and 10-2005-0135018 filed on Dec. 30, 2005, which are hereby incorporated by reference as if fully set forth herein.

### FIELD OF THE INVENTION

The present invention relates to a mobile communication terminal and display method using the same, and more particularly, to an information displaying method, object displaying method, wall paper displaying method, initial image background changing method and mobile communication terminal implementing the same. Although the present invention is suitable for a wide scope of applications, it is particularly suitable for displaying various kinds of video information on a plurality of display devices, respectively, displaying a specific object on a plurality of display devices by varying a moving direction and speed of the specific object according to gravity, and displaying a plurality of video information on a background or initial image.

### BACKGROUND OF THE INVENTION

Recently marketed mobile communication terminals offer various functions deviating from their original goals for providing simple voice communication functions. Moreover, the rapid development of mobile communications and information industrial technologies enable mobile communication terminals with various functions to be marketed in series. Specifically, display devices evolve into various models to meet the tastes of modern users sensitive to visual information. For instance, a mobile communication terminal provided with one display device evolves into a mobile communication terminal provided with a pair of display devices.

A pair of display devices can be implemented in various ways. In the related art, a wide screen is provided as a main display device and a sub-display device relatively smaller than the main display device is also provided. Accordingly, a screen of the sub-display device may display simple information such as a date, a time, a short-length text and the like. In particular, the sub-display device has difficulty displaying image information or fails to meet a user's satisfaction due to its low-definition resolution.

However, the related art has the following problems or disadvantages. First, a function for displaying specific information in various ways to meet a taste of a user sensitive to video information has not been sufficiently offered. Second, a user frequently plays a real-time mobile game with a third party using a mobile communication terminal via a mobile communication network or plays a downloaded game. Yet, the mobile communication terminal is still incapable of offering a sufficient graphic function for visually enhancing the game. Thus, the user may feel unsatisfied when playing the game. Third, a wallpaper or an initial image provided by the related art mobile communication terminal represents a single still picture or video information only, of which a user may easily get bored. Fourth, high-end hardware performance provided by a late-model mobile communication terminal is used in offering simple functions. Therefore, a user finds no significant difference between expensive and inexpensive mobile communication terminals.

### SUMMARY OF THE INVENTION

The present invention is directed to a mobile communication terminal capable of displaying information.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, the present invention is embodied in a mobile communication terminal capable of displaying information, the mobile communication terminal comprising a first display unit for displaying information, a second display unit for displaying information, a memory unit for storing displayable main information, and a control unit for controlling first sub-information of the main information displayable on the first display unit and controlling second sub-information of the main information displayable on the second display unit, wherein the first sub-information and the second sub-information are continually varied and correlated to each other for providing continuity of information between the first display unit and the second display unit.

Preferably, the control unit configures a virtual space for displaying the main information therein, maps the first and second display units to the virtual space, and decides which areas of the main information comprise first and second sub-information by discerning how the mapped first and second display units are respectively overlapped with the main information.

Preferably, the mobile communication terminal further comprises a position detecting unit for detecting a relative position between the first and second display units, wherein the control unit updates the first sub-information and the second sub-information by reflecting a variation of the relative position between the first and second display units on the virtual space.

Preferably, at least one of the first and second display units comprises a touch screen, wherein if a specific point of the touch screen is pressed, the first sub-information and the second sub-information are updated to center on the pressed point.

Preferably, the first sub-information and the second sub-information are updated to center on a randomly moving point on the first and second display units. Preferably, the main information comprises at least one of a still picture, a moving picture and animation.

In accordance with another embodiment of the present invention, a method for displaying information in a mobile communication terminal having at least two display units comprises extracting at least two sets of sub-information from displayable main information and displaying the at least two sets of sub-information on the at least two display units, respectively, wherein the at least two sets of sub-information are continually varied and correlated to each other for providing continuity of information between the at least two display units. Preferably, the main information comprises at least one of a still picture, a moving picture and animation.

In accordance with another embodiment of the present invention, a method for displaying information in a mobile communication terminal having a first display unit and a second display unit comprises configuring a virtual space for displaying main information therein, mapping the first and second display units to the virtual space, deciding which areas of the main information comprise first and second sub-information by discerning how the mapped first and second display units are respectively overlapped with the main information, and displaying the first and second sub-information on the first and second display units, respectively.

Preferably, the first and second sub-information are continually varied and correlated to each other for providing continuity of information between the first and second display units. Preferably, if a relative position between the first and second display units is varied, the steps of mapping, deciding and displaying are repeated. Preferably, the main information comprises at least one of a still picture, a moving picture and animation.

In accordance with another embodiment of the present invention, a mobile communication terminal capable of displaying information comprises a first display unit for displaying information, a second display unit for displaying information, a slope obtaining unit for obtaining slopes of the first and second display units with respect to a ground surface, respectively, and a control unit for controlling a specific object to be displayed by moving the specific object according to the obtained slopes, wherein the specific object is moved across the first and second display units and within the first or second display units.

Preferably, the obtained slopes comprise at least one of first and second roll angles of the first and second display units with respect to the ground surface in a roll axis direction and first and second yaw angles of the first and second display units with respect to the ground surface in a yaw axis direction.

Preferably, the control unit controls at least one of a moving direction and speed of the specific object using the obtained slopes to display the specific object moving across the first and second display units according to gravity. Preferably, the mobile communication terminal further comprises a memory for storing a speed table in which the moving speed is matched to at least one of a roll and yaw angle, wherein the control unit controls the moving speed of the specific object with reference to the speed table. Preferably, the control unit updates a display of the specific object on the first and second display units according to variations of the obtained slopes.

Preferably, the slope obtaining unit obtains slopes using at least one a gravity detecting sensor, a terrestrial magnetism sensor and an acceleration sensor. Preferably, the first and second display units are provided on separate bodies, respectively. Preferably, the first and second display units are provided on one body.

In accordance with another embodiment of the present invention, a method for displaying an object in a mobile communication terminal having a first display unit and a second display unit comprises obtaining slopes of the first and second display units with respect to a ground surface, respectively and controlling the object by moving the specific object according to the obtained slopes, wherein the specific object is moved across the first and second display units and within the first or second display units.

In accordance with another embodiment of the present invention, a mobile communication terminal capable of displaying information comprises a display unit for displaying information, a memory for storing a plurality of homogeneous or heterogeneous displayable contents, and a control unit for detecting an occurrence of an event for a status change of the mobile communication terminal, wherein the control unit controls a plurality of the contents to be displayed as a wall paper on the display unit in a random or predetermined sequence each time the occurrence of the event is detected.

Preferably, the event corresponds to the display unit entering an active status from an inactive status. Preferably, the event corresponds to an input signal received via an input unit provided on the mobile communication terminal. Preferably, the event corresponds to a radio signal received from a mobile communication network via a mobile communication module provided on the mobile communication terminal. Preferably, the event corresponds a strength of a radio signal received from a mobile communication network via a mobile communication module provided on the mobile communication terminal reaching a prescribed level. Preferably, the event corresponds a strength of power supplied from a power supply unit provided on the mobile communication terminal reaching a prescribed level.

Preferably, the control unit varies a display sequence of a plurality of the contents or a type of the contents to be displayed according to a time of the detected occurrence of the event. Preferably, the control unit controls a whole or partial portion of a specific one of a plurality of contents (contents A) and a whole or partial portion of a next one of a plurality of contents (contents B) to be simultaneously displayed during a prescribed time. Preferably, during the prescribed time, the control unit controls the contents A to become dimmer to disappear and the contents B to become clearer from a dim status.

Preferably, the contents include at least one of a message receive/sent by a short message service (SMS), a message received/sent by a multimedia messaging service (MMS), text, a still picture, a moving picture, and animation. Preferably, the mobile communication terminal further comprises an audio output unit, wherein the memory stores at least one audio content and the control unit controls the at least one audio content to be outputted via the audio output unit according to a detection of the event.

In accordance with another embodiment of the present invention, a method for displaying a wall paper in a mobile communication terminal comprises detecting an occurrence of an event for a status change of the mobile communication terminal, and controlling a plurality of contents to be displayed as a wall paper on a display unit provided on the mobile communication terminal in a random or predetermined sequence each time the occurrence of the event is detected.

Preferably, the event corresponds to a radio signal received from a mobile communication network via a mobile communication module provided on the mobile communication terminal.

Preferably, in the controlling step, a display sequence of a plurality of contents is varied according to a time of the detected occurrence of the event. Preferably, in the controlling step, a whole or partial portion of a specific one of a plurality of contents (contents A) and a whole or partial portion of a next one of a plurality of contents (contents B) are simultaneously displayed during a prescribed time. Preferably, in the controlling step, during the prescribed time, the contents A becomes dimmer to disappear and the contents B becomes clearer from a dim status.

Preferably, the contents include at least one of a message received/sent by a short message service (SMS), a message received/sent by a multimedia messaging service (MMS), text, a still picture, a moving picture, and animation. Preferably, the method further comprises playing audio contents according to the detected event.

In accordance with another embodiment of the present invention, a method for changing a background of an initial image in a mobile communication terminal comprises entering the initial image of the mobile communication terminal and changing background information of the initial image each time the initial image is entered, wherein the background information comprises at least one of still pictures, a plurality of moving pictures, a plurality of texts and a plurality of background music.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention.

FIG. 1 is a block diagram of a mobile communication terminal in accordance with a first embodiment of the present invention.

FIG. 2 is a diagram illustrating two sets of sub-information having information continuity between them being displayed on two screens, respectively, in accordance with one embodiment of the present invention.

FIG. 3 is a diagram illustrating animation being displayed on two screens in accordance with one embodiment of the present invention.

FIG. 4 is a diagram of a virtual space used for a continuous display of information in accordance with one embodiment of the present invention.

FIG. 5 is a diagram illustrating another example of a continuous display of information in accordance with one embodiment of the present invention.

FIG. 6 is a diagram illustrating a further example of a continuous display of information in accordance with one embodiment of the present invention.

FIG. 7 is a flowchart of a method for displaying information in accordance with a second embodiment of the present invention.

FIG. 8 is a flowchart of a method for displaying information in accordance with a third embodiment of the present invention.

FIG. 9 is a block diagram of a mobile communication terminal in accordance with a fourth embodiment of the present invention.

FIG. 10 illustrates axes for defining an operation of a mobile communication terminal in accordance with a fourth embodiment of the present invention.

FIGS. 11A to 11D are diagrams of a sandglass, in which sand is displayed in a gravity direction in accordance with the fourth embodiment of the present invention.

FIG. 12 is a diagram of a slide type terminal for explaining a roll action in accordance with one embodiment of the present invention.

FIG. 13 is a diagram of a folder type terminal for explaining a roll action in accordance with one embodiment of the present invention.

FIG. 14 is a block diagram of a mobile communication terminal in accordance with a fifth embodiment of the present invention.

FIG. 15 is a block diagram of a mobile communication terminal in accordance with a sixth embodiment of the present invention.

FIG. 16 is a flowchart of a method for displaying an object in accordance with a seventh embodiment of the present invention.

FIG. 17 is a block diagram of a mobile communication terminal in accordance with an eighth embodiment of the present invention.

FIG. 18 is a flowchart of a method for displaying a wall paper in accordance with a ninth embodiment of the present invention.

FIG. 19 is a diagram of a plurality of still pictures being displayed as wall paper in accordance with the eighth and ninth embodiments of the present invention.

FIG. 20 is a flowchart of a method for changing a background of an initial image in a mobile communication terminal in accordance with a tenth embodiment of the present invention.

FIG. 21 is a diagram of a displayed initial image interconnected across a pair of display units according to a tenth embodiment of the present invention.

### DETAILED DESCRIPTION OF THE PREFERRED EMBODIMENTS

The present invention is related to a mobile communication terminal capable of displaying information.

Reference will now be made in detail to the preferred embodiments of the present invention, examples of which are illustrated in the accompanying drawings. Wherever possible, the same reference numbers will be used throughout the drawings to refer to the same or like parts.

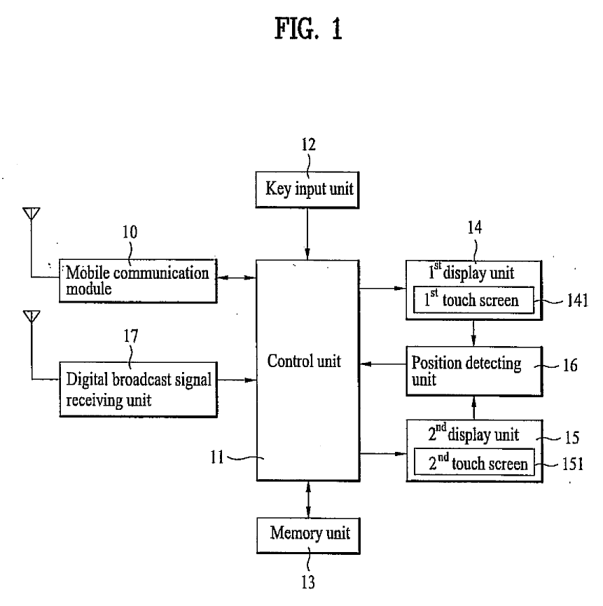

FIG. 1 is a block diagram of a mobile communication terminal according to a first embodiment of the present invention. Referring to FIG. 1, a mobile communication terminal according to a first embodiment of the present invention includes a mobile communication module 10, a control unit 11, a key input unit 12, a memory unit 13, a first display unit 14, a second display unit 15 and a position detecting unit 16. Notably, the mobile communication terminal according to the first embodiment of the present invention can include more than two display units. However, for the convenience of explanation, only the first and second display units 14 and 15 are identified in the mobile communication terminal according to the first embodiment of the present invention.

Basic functions of the above-mentioned elements are explained as follows. First, the mobile communication module 10 is a communication device for transmitting and receiving data via a mobile communication network. The control unit 11 collectively manages overall operations of the mobile communication terminal. The key input unit 12 is an input device provided with various keys including numerical keys and the like to receive various commands from a user.

The memory unit 13 stores a prescribed program to control the overall operation of the mobile communication terminal. The memory unit 13 also stores data inputted/outputted when operations of the mobile communication terminal are executed by the control unit 11, and the memory unit 13 also stores various processed data.

The first and second display units 14 and 15 are display devices for displaying a status of the mobile communication terminal and various kinds of information. The first and second display units 14 and 15 can be provided on different bodies, respectively. Alternatively, the first and second display units 14 and 15 can be built in one body.

The position detecting unit 16 is a device that detects a relative position between the first and second display units 14 and 15. If the first and second display units 14 and 15 are built in one body, the relative position maybe a fixed value. However, if the first and second display units 14 and 15 are provided on different bodies, respectively, the relative position varies according to a variation of each of the different bodies.

The mobile communication terminal can further include a touch screen provided as a user interface, separate from the key input unit 12, to at least one of the first and second display units 14 and 15. In this case, a reference number 141 indicates a first touch screen and a reference number 151 indicates a second touch screen.

Meanwhile, the mobile communication terminal according to the first embodiment of the present invention can further include a digital broadcast signal receiving unit 17 receiving a digital broadcast signal from a broadcasting network. Hence, the mobile communication terminal further including the digital broadcast signal receiving unit 17 is capable of both a communication function and a broadcast receiving function.

The mobile communication terminal according to the first embodiment of the present invention is explained in detail with reference to the operation of the control unit 11 as follows. First, the memory unit 13 stores main information that is displayable. The main information includes image data such as animation, a moving picture, a still picture and the like, and various kinds of information displayable via the first or second display units 14 or 15. And, the main information can be externally received via the mobile communication module 10 or the digital broadcast signal receiving unit 17.

The control unit 11 extracts first sub-information and second sub-information from the main information stored in the memory unit 13. The first sub-information and the second sub-information belong to the main information and have information continuity between them. Specifically, in case that information (main information) displayable on one screen is divided to be displayed onto two screens, the information continuity provides a correlation between two sets of information (first and second sub-information) divided to be displayed on the two screens, respectively. Preferably, if the first and second sub-information having the information continuity between them are displayed on one screen, one complete set of information is configured without information discontinuity. Furthermore, the number of sets of sub-information having information continuity extractable from the main information by the control unit 11 is not limited to two. More sets of sub-information can be extracted. Preferably, the main information dynamically varies and the first and second sets of sub-information dynamically vary according to the dynamic variation of the main information.

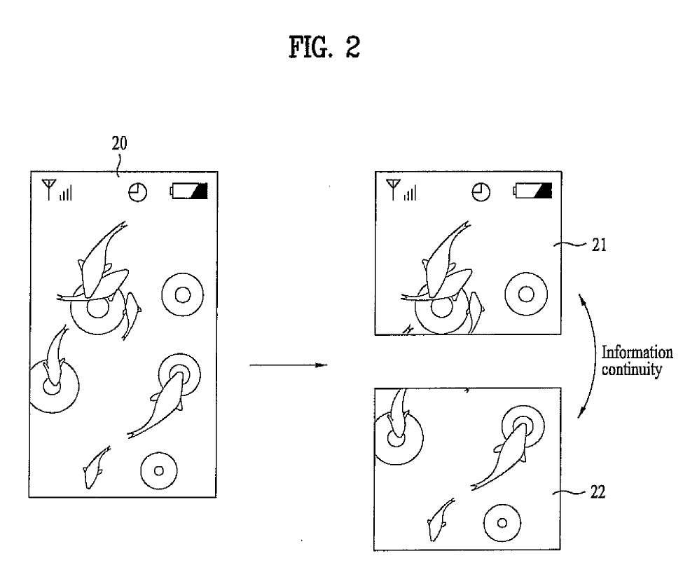

FIG. 2 is a diagram illustrating two sets of sub-information having information continuity between them being displayed on two screens, respectively, in accordance with one embodiment of the present invention. Referring to FIG. 2, animation displayable on one screen 20 is divided into two parts to be displayed on two screens 21 and 22, respectively. For the convenience of explanation in FIG. 2, a size of an upper screen 21 is equal to that of a lower screen 22 and the animation displayed on the screen 20 is divided into halves to be respectively displayed. However, at least two sets of sub-information having information continuity between them can be displayed in various ways according to a size of a display device, a type of the display device, a type of displayed information, etc.

The control unit 11 outputs a control signal to display the extracted first sub-information on the first display unit 14 and the extracted second sub-information on the second display unit 15. The first and second display units 14 and 15 perform display operations according to the control signal.

In case that the mobile communication terminal according to the first embodiment of the present invention includes at least two or more display units, the control unit 11 extracts at least two sets of sub-information, having mutual information continuity, from the main information and controls the extracted at least two sets of sub-information to be displayed on the at least two display units, respectively. In this case, the number of the extracted at least two sets of sub-information is preferably equal to or smaller than the number of the at least two display units.

Preferably, the first and second sets of sub-information are not to indicate an importance or sequence of information, but to discriminate the information displayed on the first and second display units 14 and 15, respectively. Therefore, it is not necessary to display the first and second sets of sub-information on the first and second display units 14 and 15, respectively. Instead, a sequence for displaying the first and second sets of sub-information on the first and second display units 14 and 15 can be switched.

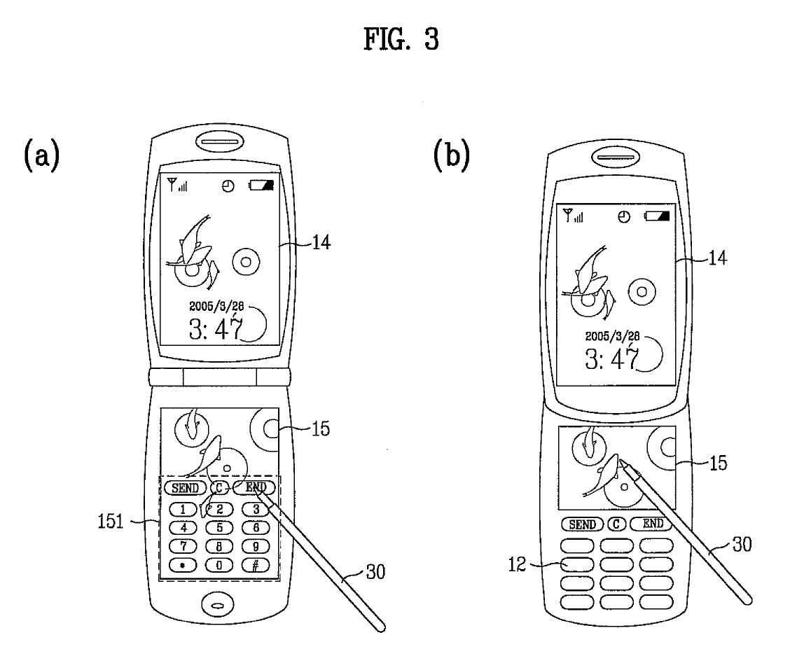

FIG. 3 is a diagram illustrating animation being displayed on two screens in accordance with one embodiment of the present invention. In FIG. 3, a folder type terminal is shown in (a) of FIG. 3 and a slide type terminal is shown in (b) of FIG. 3. An example of displaying first and second sets of sub-information, having mutual information continuity, on first and second display units 14 and 15, respectively, is explained as follows.

Referring to FIG. 3, animation depicting fish swimming in the sea is divided into two parts to be displayed on two screens, respectively. The fish are displayed by moving across the first and second display units 14 and 15. Accordingly, there exists mutual information continuity between a first sub-animation displayed on the first display unit 14 and a second sub-animation displayed on the second display unit 15.

The example shown in FIG. 3 is applicable to various applications. For instance, the display example shown in FIG. 3 can be used as wall paper for a mobile communication terminal. Moreover, FIG. 3 also illustrates an example of a second touch screen 151 provided to the second display unit 15 as a user interface separate from the key input unit 12. Preferably, a user can conduct various inputs using a finger or stylus pen 30 on the touch screen 151.

Additionally, the control unit 11 is able to extract a plurality of sets of sub-information having mutual information continuity from the main information stored in the memory unit 13 in various ways. In the present invention, the sets of sub-information may be extracted using a virtual space or screen.

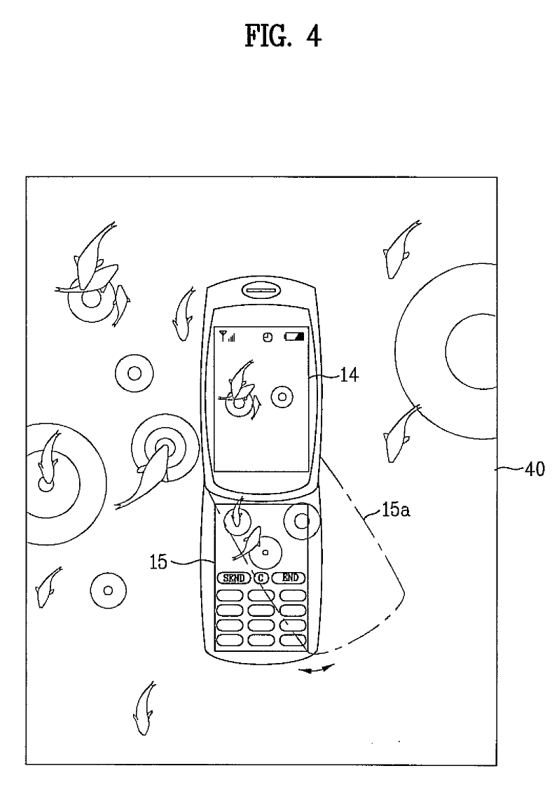

FIG. 4 is a diagram of a virtual space used for a continuous display of information in accordance with one embodiment of the present invention. An operational principle of the control unit 11 using the virtual space to control a continuous display of information is explained in detail with reference to FIG. 4 as follows.

Referring to FIG. 4, the control unit 11 configures a prescribed virtual space 40 in the memory unit 13 and controls the main information, which is stored in the memory unit 13, on/in the virtual space 40. In this case, the virtual space can be 2-dimensional or 3-dimensional. Preferably, a dimension of the virtual space depends on information to be displayed on/in the virtual space. As shown in FIG. 4, the main information displayed as an example of the virtual space 40 is animation depicting fish swimming in the sea.

The control unit 11 maps the first and second display units 14 and 15 to the virtual space 40. The control unit 11 also decides areas, in which the mapped first and second display units 14 and 15 are overlapped with the displayed main information in the virtual space 40, as the first and second sets of sub-information, respectively.

In case that the mobile communication terminal according to one embodiment of the present invention includes at least two display units, then at least two or more sets of sub-information are decided in the above-explained manner. Moreover, the control unit 11 controls the decided first and second sets of sub-information to be displayed on the first and second display units 14 and 15, respectively.

Meanwhile, as mentioned in the foregoing description, the first and second display units 14 and 15 can be provided on two different bodies, respectively. In this case, one of the two different bodies can be turned against the other to form a prescribed angle between an original position of the display unit 15 and a new position of the display unit 15 represented by numeral 15a (15→15a). A terminal having this configuration is called a swing type terminal. In FIG. 4, if the second display unit 15 is turned to the status 15a, a screen of the second display unit 15 needs to be updated.

Accordingly, the control unit 11 receives a relative position between the first and second display units 14 and 15 from the position detecting unit 16. If a variation of the received relative position takes place, the control unit 11 reflects the variation on the virtual space 40 to update the first and second sets of sub-information.

The update of the virtual space mapping using the position detecting unit 16 is exemplary. And, the corresponding update can be achieved in various ways. For instance, the virtual space mapping can be updated using a means for obtaining a presence or non-presence and degree of a rotation of each of the bodies provided with the first and second display units 14 and 15, respectively. Furthermore, the virtual space 40 may be set to be turned by inter-working with a relative position variation of the second display unit 15 in status 15a against the first display unit 14.

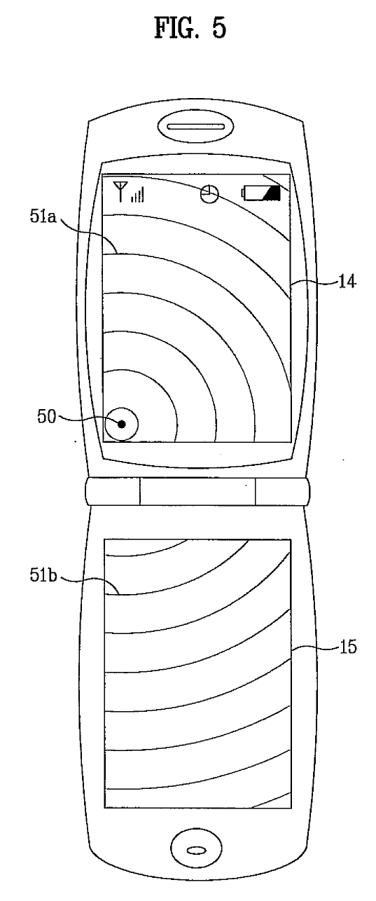

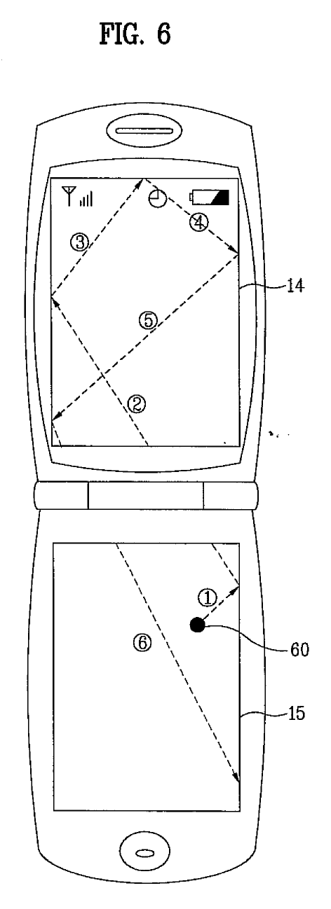

FIG. 5 is a diagram illustrating another example of a continuous display of information in accordance with one embodiment of the present invention. FIG. 6 is a diagram illustrating a further example of a continuous display of information in accordance with one embodiment of the present invention.

Referring to FIG. 5, waves propagating from a wave origin 50 are displayed. Reference numbers 51a and 51b indicate spherical waves equally distant from the wave origin 50. The spherical waves 51a and 51b, having mutual information continuity, are displayed on the first and second display units 14 and 15, respectively. In FIG. 5, first and second sets of sub-information dynamically vary centering on a touch point inputted via the touch screens 141 and 151, respectively. Alternatively, the first and second sets of sub-information dynamically vary centering on points randomly moving on the first and second display units 14 and 15, respectively. In particular, if a new wave origin is designated by pressing a prescribed point on the first or second touch screen 141 or 151 using a user's finger or stylus pen, new waves can be made to propagate from the new wave origin. Alternatively, the wave origin 50 can be made to vary according to an external input via the key input unit 12 or a time duration. Moreover, new waves are displayed centering on the varied wave origin according to a position variation of the wave origin 50.

Referring to FIG. 6, a bead type object 60 is displayed hitting a wall to be reflected. Preferably, the object 60 starts from a prescribed point of the second display unit 15 and moves across the second and first display units 15 and 14 (Bead proceeding sequence: 1→2→3→4→5→6).

The display examples shown in FIG. 5 and FIG. 6 are applicable to various applications similar to the former display example shown in FIG. 3. For instance, the display example shown in FIG. 5 or FIG. 6 may be used as a wall paper or a background picture when an incoming call is received. In another instance, the example shown in FIG. 6 may be used as a billiard game loadable within a mobile communication terminal.

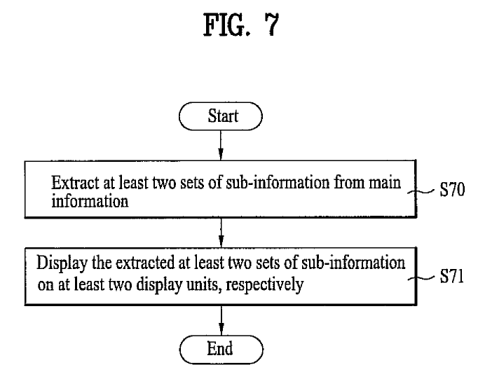

FIG. 7 is a flowchart of a method for displaying information in accordance with a second embodiment of the present invention. A method for displaying information according to a second embodiment of the present invention in a mobile communication terminal provided with at least two display units is explained in detail as follows.

Referring to FIG. 7, at least two sets of sub-information are extracted from main information that is displayable [S70]. The extracted at least two sets of sub-information have mutual information continuity and dynamically vary. The main information, the at least two sets of sub-information and the information continuity are equivalent to those explained for the mobile communication terminal according to the first embodiment of the present invention. Preferably, the number of the extracted at least two sets of sub-information is equal to or smaller than the number of display units provided on the mobile communication terminal.

Subsequently, the extracted at least two sets of sub-information are displayed on at least two display units, respectively [S71]. If a relative position between the at least two display units is varied, it is preferable that the steps S70 and S71 are repeated to update the contents displayed on the at least two display units.

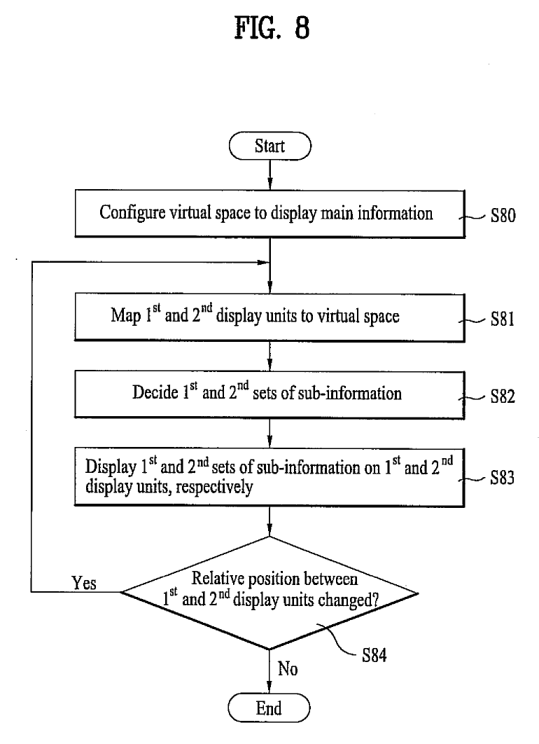

FIG. 8 is a flowchart of a method for displaying information in accordance with a third embodiment of the present invention. A method of displaying information according to a third embodiment of the present invention in a mobile communication terminal provided with first and second display units is explained in detail as follows.

Referring to FIG. 8, a virtual space for displaying main information is configured [S80]. Preferably, the main information and the virtual space are equivalent to those explained for the mobile communication terminal according to the first embodiment of the present invention. However, the virtual space can be configured in a memory or buffer provided on the mobile communication terminal.

Subsequently, the first and second display units are mapped to the configured virtual space [S81]. Areas, in which the mapped first and second display units are overlapped with the main information, are decided to be first and second sets of sub-information, respectively [S82]. Detailed features of the first and second sets of sub-information are equivalent to those explained for the mobile communication terminal according to the first embodiment of the present invention. In particular, it is preferable that the first and second sets of sub-information have mutual information continuity in order to dynamically vary.

Subsequently, the decided first and second sets of sub-information are displayed on the first and second display units, respectively [S83]. It is then decided whether a relative position between the first and second display units is varied [S84]. As a result of the decision, if the relative position between the first and second display units is varied, it is preferable that the steps S81 to S83 are repeated to update contents displayed on the first and second display units.

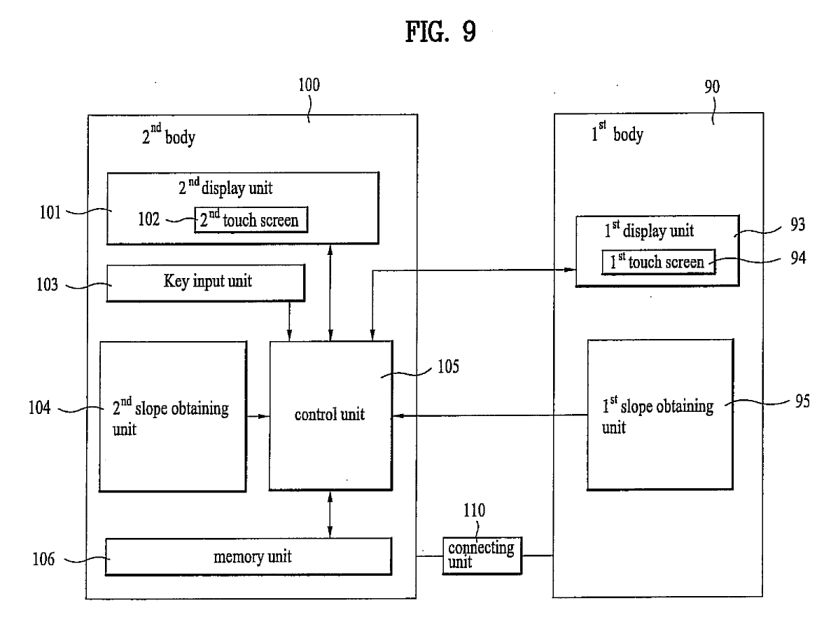

FIG. 9 is a block diagram of a mobile communication terminal in accordance with a fourth embodiment of the present invention. A mobile communication terminal according to a fourth embodiment of the present invention is explained in detail as follows.

Referring to FIG. 9, a mobile communication terminal according to a fourth embodiment of the present invention includes a first body 90, a second body 100 and a connecting unit 110. The first body 90 includes a first display unit 93 and a first slope obtaining unit 95. The second body 100 includes a second display unit 101, a key input unit 103, a second slope obtaining unit 104, a control unit 105 and a memory unit 106. As shown, the key input unit 103, the control unit 105 and the memory unit 106 are provided on the second body 100; however, they also can be provided on the first body 90.

For executing basic functions as a mobile communication terminal, the mobile communication terminal according to the fourth embodiment of the present invention includes a mobile communication module (not shown in the drawing) as a communication device for data transmission and reception with a mobile communication network. The mobile communication module may be provided on the first body 90 or the second body 100.

Basic functions of the elements described above are explained as follows. First, the first and second display units 93 and 101 are display devices displaying a status of the mobile communication terminal and various kinds of information. The key input unit 103 is an input device provided with various keys including numeral keys and the like to receive various commands from a user.

The mobile communication terminal can further include a touch screen provided as a user interface, separate from the key input unit 103, to at least one of the first and second display units 93 and 101. In this case, a reference number 94 indicates a first touch screen and a reference number 102 indicates a second touch screen.

The control unit 105 collectively manages overall operations of the mobile communication terminal. The memory unit 106 stores a prescribed program to control the overall operation of the mobile communication terminal. The memory unit 106 also stores data inputted/outputted during execution of the overall operation of the mobile communication terminal by the control unit 105. Furthermore, the memory unit 106 also stores various processed data.

The connecting unit 110 is a device for connecting the first body 90 and the second body 100 together. A terminal type according to a connecting mechanism of the first body 90 and the second body 100 is decided as a folder type, a slide type or a swing type by features of the connecting unit 110.

Meanwhile, the mobile communication terminal according to the fourth embodiment of the present invention can further include a digital broadcast signal receiving unit (not shown in the drawing) for receiving a digital broadcast signal from a broadcasting network. Hence, the mobile communication terminal including the mobile communication module and the digital broadcast signal receiving unit is capable of both a communication function and a broadcast receiving function.

The first slope obtaining unit 95 and the second slope obtaining unit 104 obtain slopes of the first body 90 and the second body 100 against a ground surface, respectively.

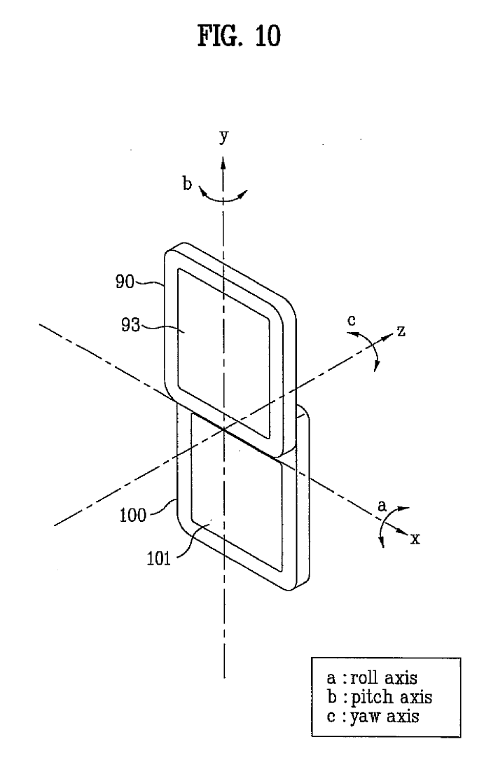

FIG. 10 illustrates axes for defining an operation of a mobile communication terminal in accordance with a fourth embodiment of the present invention. Referring to FIG. 10, motion in an a-direction is called a roll action. Motion in a b-direction is called a pitch action. Motion in a c-direction is called a yaw action.

In the present invention, the x-axis, y-axis and z-axis are defined as a roll axis, a pitch axis and a yaw axis, respectively. Angles of the first body 90 and the second body 100 against an x-axis in FIG. 10 are defined as first and second yaw angles, respectively. Angles of the first body 90 and the second body 100 against a z-axis in FIG. 10 are defined as first and second roll angles, respectively. A y-axis in FIG. 10 is an axis vertical to a ground surface to indicate a direction of gravity. Moreover, an x-z plane indicates a plane parallel to the ground surface.

The first slope obtaining unit 95 obtains at least one of the first roll angle of the first body 90 against the ground surface in the direction of the roll axis and the first yaw angle of the first body 90 against the ground surface in the direction of the yaw axis. The second slope obtaining unit 104 obtains at least one of the second roll angle of the second body 100 against the ground surface in the direction of the roll axis and the second yaw angle of the second body 100 against the ground surface in the direction of the yaw axis.

At least one of the first slope obtaining unit 95 and the second slope obtaining unit 104 can obtain at least one of the first/second roll angle and the first/second yaw angle using at least one of a gravity detecting sensor, a terrestrial magnetism sensor and an acceleration sensor.

In case that one of the first slope obtaining unit 95 and the second slope obtaining unit 104 uses one of the gravity detecting sensor, the terrestrial magnetism sensor and the acceleration sensor, the other one of the first slope obtaining unit 95 and the second slope obtaining unit 104 can use a position detecting sensor for detecting an angle against another body. In particular, even if one of the first slope obtaining unit 95 and the second slope obtaining unit 104 is provided with one of the gravity detecting sensor, the terrestrial magnetism sensor and the acceleration sensor, both slopes of the first body 90 and the second body 100 against the ground surface can be obtained. This is because a relative angle (slope) between two completely open bodies of a terminal is already determined in case of the folder, slide or swing type terminal including the two bodies.

Meanwhile, in case of opening the swing type terminal of which a relative angle between two bodies is varied, a slope against the ground surface is obtained using one of the gravity detecting sensor, the terrestrial magnetism sensor and the acceleration sensor. A relative slope against the other body is detected using the position detecting sensor. Hence, the slope against the ground surface can be obtained.

The mobile communication terminal according to the fourth embodiment of the present invention is explained in detail with reference to the operation of the control unit 105 as follows. First, the control unit 105 controls a specific object to be displayed by moving the specific object according to the slopes obtained by the first slope obtaining unit 95 and the second slope obtaining unit 104. Furthermore, the control unit 105 controls the specific object to move between the first display unit 93 and the second display unit 101 as well as within the first display unit 93 or the second display unit 101.

To implement the display function according to the fourth embodiment of the present invention, the control unit 105 can employ a control method, such as a (1) Moving Direction Control; (2) Moving Speed Control; (3) Simultaneous Control of Moving Direction and Moving Speed; or (4) Configuration Control.

(1) Moving Direction Control of Specific Object

The control unit 105 is able to control a specific object displayed on the first display unit 93 or the second display unit 101 to move in a direction of gravity using the first and second roll angles and the first and second yaw angles obtained by the first and second slope obtaining units 95 and 104, respectively.

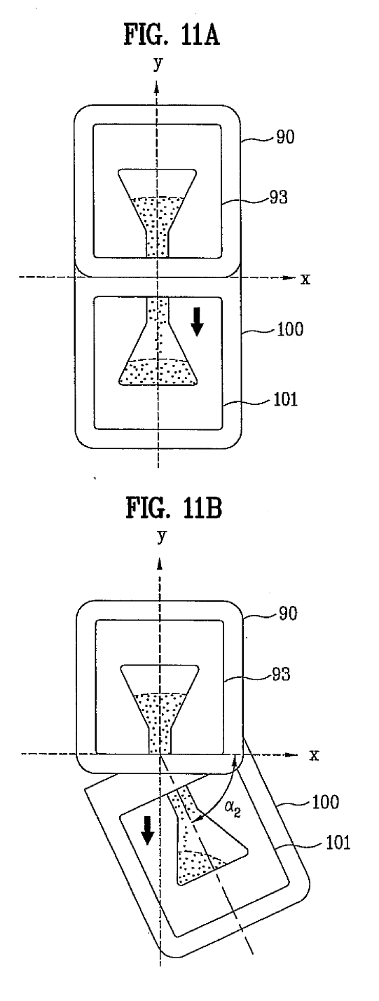

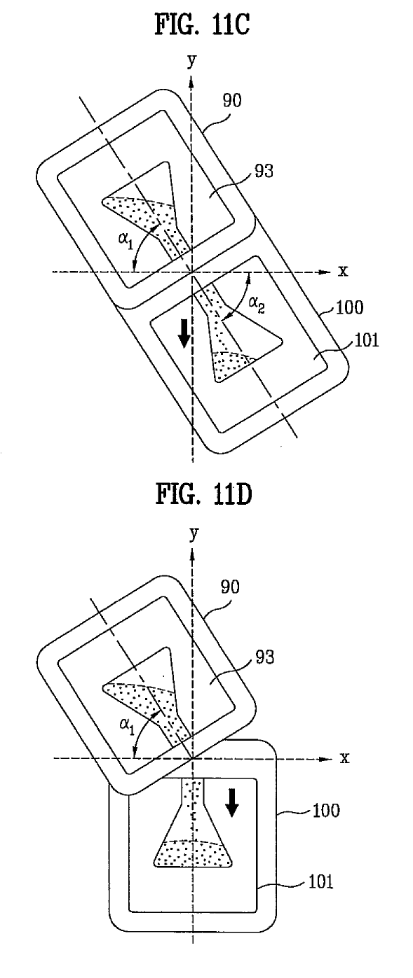

A case where a display of a specific object is varied by a yaw action of a mobile communication terminal is explained as follows. FIGS. 11A to 11D are diagrams of a sandglass, in which sand is displayed in a direction of gravity according to the fourth embodiment of the present invention. In the mobile communication terminal shown in FIGS. 11A to 11D, it is assumed that the first body 90 and the second body 100 can configure a relatively random angle on an x-y plane. Preferably, this assumption can be implemented by the connecting unit 110.

An operation for displaying a specific object by moving the specific object in a direction of gravity by detecting a yaw action of a mobile communication terminal according to one embodiment of the present invention is explained as follows. In FIGS. 11A to 11D, each arrow indicates a gravity direction. Moreover, α1 and α2 indicate the first and second yaw angles obtained by the first slope obtaining unit 95 and the second slope obtaining unit 104, respectively. A y-axis indicates an axis vertical to a ground surface.

FIG. 11A illustrates a case where each of the first body 90 and the second body 100 is perpendicular to an x-axis and is parallel to the y-axis. Since each of α1 and α2 is 90°, sand is displayed moving vertically toward the second display unit 101 from the first display unit 93.

FIG. 11B illustrates a case where the first body 90 is perpendicular to the x-axis and parallel to the y-axis. However, the second body 100 configures an angle α2 between 0° and 90° (0°<α2<90°).

FIG. 11C illustrates a case where each of the first body 90 and the second body 100 configure an angle α1=α2 between 0° and 90° (0°<α1=α2<90°).

FIG. 11D illustrates a case where the second body 100 is perpendicular to the x-axis and parallel to the y-axis. However, the first body 90 configures an angle α1 between 0° and 90° (0°<α1<90°).

As shown in FIGS. 11A to 11D, the sand within the sandglass is displayed moving in the gravity direction (vertical to x-axis and parallel to y-axis).

A case where a display of a specific object is varied according to a roll action of a mobile communication terminal is explained as follows. First, a moving direction of a specific object is varied by a roll action of a mobile communication terminal if a relative position between the first body 90 and the second body 100 against a ground surface is varied. In particular, when the first body 90 is more distant from the ground surface than the second body 100, a specific object will be displayed moving from the first display unit 93 toward the second display unit 101. If the second body 100 becomes more distant from the ground surface than the first body 90 by the roll action of the mobile communication terminal, the specific object will be displayed moving from the second display unit 101 toward the first display unit 93. If at least one of the first and second roll and yaw angles is varied, the control unit 105 preferably updates contents displayed on the first display unit 93 and the second display unit 101 to correspond to the variation.

(2) Moving Speed Control of Specific Object

The control unit 105 is able to control a moving speed of a specific object displayed on the first display unit 93 or the second display unit 101 using the first and second roll and yaw angles obtained by the first slope obtaining unit 95 and the second slope obtaining unit 104, respectively.

A case for controlling a moving speed of a specific object according to a roll angle is explained as follows. In this case, β1 and β2 indicate first and second roll angles obtained by the first slope obtaining unit 95 and the second slope obtaining unit 104, respectively.

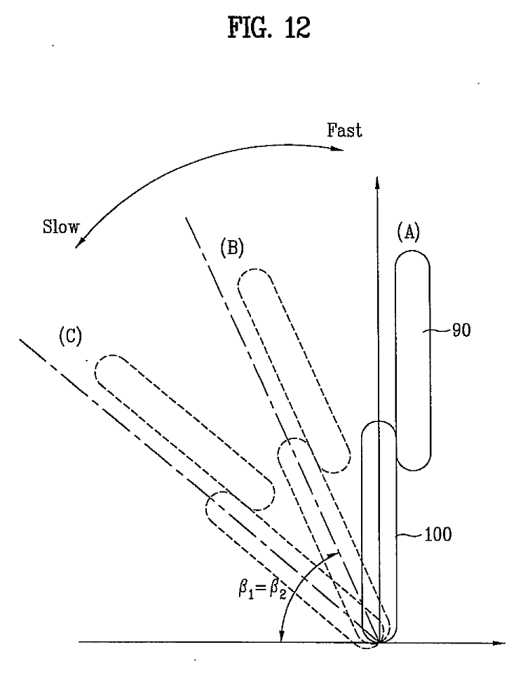

FIG. 12 is a diagram of a slide type terminal for explaining a roll action in accordance with one embodiment of the present invention. Referring to FIG. 12, the first body 90 is parallel to the second body 100 in the slide type terminal. Therefore, β1 is equal to β2 (β1=β2). If a status A of the terminal moves to a status C via a status B, a moving speed of a specific object (e.g., sand in a sandglass) in the first display unit 93 or the second display unit 101 becomes slower.

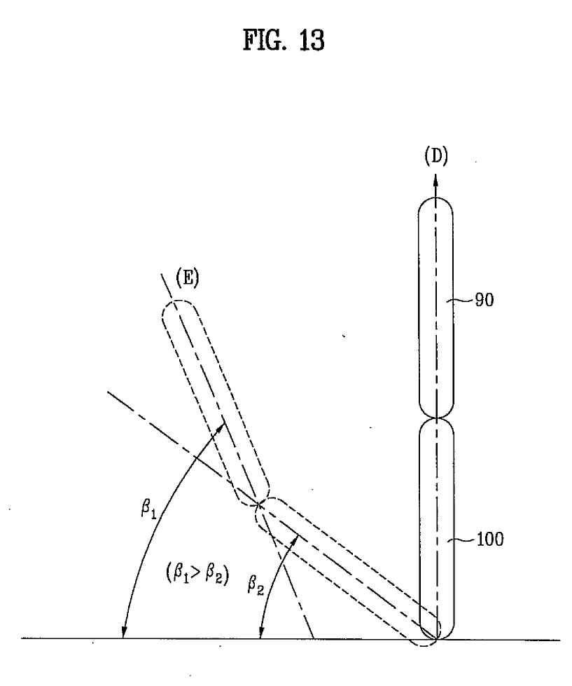

FIG. 13 is a diagram of a folder type terminal for explaining a roll action in accordance with one embodiment of the present invention. Referring to FIG. 13, the first body 90 and the second body 100 can relatively configure an arbitrary angle in the folder type terminal. Therefore, β1 and β2, as indicated by a status E in FIG. 13, can be different from each other.

In a status D of FIG. 13, a moving speed of a specific object in the first display unit 93 is equal to that of the specific object in the second display unit 101. However, in the status (E) of FIG. 13, because β1 is greater than β2 (β1>β2), the moving speed of the specific object in the first display unit 93 is greater than the moving speed of the specific object in the second display unit 101.

If at least one of the first and second roll angles is varied, the control unit 105 preferably updates contents displayed in the first display unit 93 and the second display unit 101 to correspond to the variation. Moreover, an operation of the control unit 105 controlling the moving speed by a yaw action of the mobile communication terminal is similar to controlling the moving speed by the aforesaid roll action. Thus, a detailed explanation for controlling the moving speed by the yaw action is omitted in the following description.

Meanwhile, the memory unit 106 stores a speed table in which a moving speed is matched to at least one of the roll and yaw angles. Preferably, the control unit 105 controls the moving speed of the specific object with reference to the speed table stored in the memory unit 106.

(3) Simultaneous Control of Moving Speed and Direction of Specific Object

The control unit 105 is able to simultaneously control a specific object displayed on the first display unit 93 and the second display unit 101 to move in a gravity direction and control a moving speed of the specific object using the first and second roll angles and the first and second yaw angles obtained by the first slope obtaining unit 95 and the second slope obtaining unit 104, respectively. Preferably, if at least one of the first and second roll and yaw angles is varied, the control unit 105 updates contents displayed on the first display unit 93 and the second display unit 101 to correspond to the variation.

(4) Configuration Control of Specific Object

The control unit 105 is able to control a specific object displayed on the first display unit and the second display unit 101 such that the specific object is arranged and displayed according to the effects of gravity. This is accomplished using the first and second roll angles and the first and second yaw angles obtained by the first slope obtaining unit 95 and the second slope obtaining unit 104, respectively.

For instance, as shown in FIG. 11B, the control unit 105 controls a line or plane configured by the sand within the sandglass, displayed on the first display unit 93 and the second display unit 101, to remain parallel to the ground surface at all times. Meanwhile, the configuration control of the specific object is preferably performed together with a control method, such as a (1) Moving Direction Control, (2) Moving Speed Control or (3) Simultaneous Control of Moving Direction and Speed.

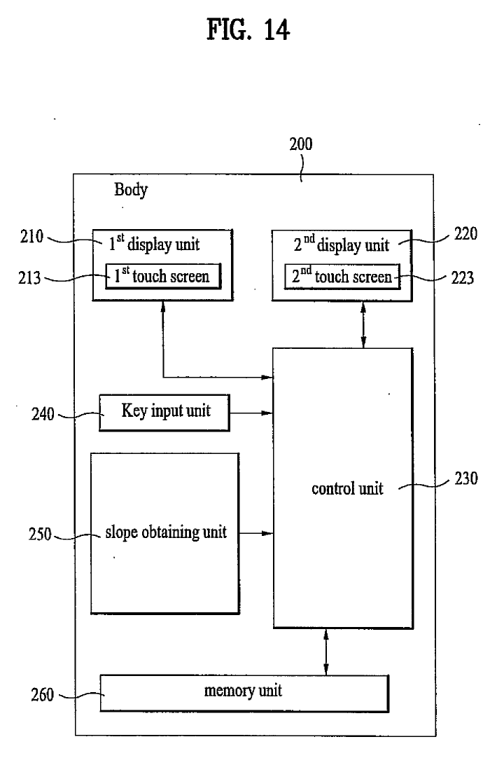

FIG. 14 is a block diagram of a mobile communication terminal in accordance with a fifth embodiment of the present invention. A mobile communication terminal according to the fifth embodiment of the present invention is explained in detail as follows.

Referring to FIG. 14, a mobile communication terminal according to the fifth embodiment of the present invention includes a single body 200. The body 200 includes a first display unit 210, a second display unit 220, a control unit 230, a key input unit 240, a slope obtaining unit 250 and a memory unit 260.

Like the former mobile communication terminal according to the fourth embodiment of the present invention, the mobile communication terminal according to the fifth embodiment of the present invention can include a mobile communication module (not shown in the drawing) for performing basic functions of a mobile communication terminal, such as data transmission and reception with a mobile communication network. Preferably, the mobile communication module can be provided on a prescribed part of the body 200.

Basic functions of the above elements are explained as follows. First, the first and display unit 210 and the second display unit 220 are display devices displaying a status of the mobile communication terminal and various kinds of information. The control unit 230 collectively manages overall operations of the mobile communication terminal. The key input unit 240 is an input device provided with various keys including numeral keys and the like to receive various commands from a user.

Like the former mobile communication terminal according to the fourth embodiment of the present invention, the mobile communication terminal according to the fifth embodiment of the present invention can further include first and second touch screens 213 and 223 provided as user interfaces separate from the key input unit 240.

The slope obtaining unit 250 obtains slopes of the first display unit 210 and the second display unit 220 against a ground surface, respectively. In particular, the slope obtaining unit 250 obtains at least one of a roll angle between the body 200 and the ground surface in a roll axis direction and a yaw angle between the body 200 and the ground surface in a yaw axis direction. The slope obtaining unit 250 can also obtain at least one of the roll and yaw angles using at least one of a gravity detecting sensor, a terrestrial magnetism sensor and an acceleration sensor.

The memory unit 260 stores a prescribed program to control the overall operation of the mobile communication terminal. The memory unit 260 also stores data inputted/outputted during execution of the overall operation of the mobile communication terminal by the control unit 230. Moreover, the memory unit 260 stores various processed data. Specifically, the memory unit 260 stores a speed table in which at least one of the roll and yaw angles is matched to a moving speed.

Preferably, the mobile communication terminal according to the fifth embodiment of the present invention can further include a digital broadcast signal receiving unit (not shown in the drawing) for receiving a digital broadcast signal from a broadcasting network. Accordingly, the mobile communication terminal including the mobile communication module and the digital broadcast signal receiving unit is capable of both a communication function and a broadcast receiving function.

The mobile communication terminal according to the fifth embodiment of the present invention is explained in detail with reference to the operations of the control unit 230 as follows. First, the control unit 230 controls a specific object to be displayed by moving the specific object according to the slope obtained by the slope obtaining unit 250. Furthermore, the control unit 230 controls the specific object to move between the first display unit 210 and the second display unit 220 as well as within the first display unit 210 or the second display unit 220.

Like the fourth embodiment of the present invention, in order to implement the display function according to the fifth embodiment of the present invention, the control unit 230 can employ a control method, such as a (1) Moving Direction Control; (2) Moving Speed Control; (3) Simultaneous Control of Moving Direction and Moving Speed; or (4) Configuration Control.

First, the control unit 230 is able to control a specific object, displayed on the first display unit 210 or the second display unit 220, to move in a direction of gravity using the roll and yaw angles obtained by the slope obtaining unit 250 (Moving Direction Control).

Furthermore, the control unit 230 is able to control a moving speed of a specific object displayed on the first display unit 210 or the second display unit 220 using the roll and yaw angles obtained by the slope obtaining unit 250 (Moving Speed Control of Specific Object).

Moreover, the control unit 230 is able to simultaneously control a specific object displayed on the first display unit 210 and the second display unit 220 to move in a gravity direction and control a moving speed of the specific object using the roll and yaw angles obtained by the slope obtaining unit 250 (Simultaneous Control of Moving Speed and Direction of Specific Object).

The control unit 230 is also able to control a specific object displayed on the first display unit 210 and the second display unit 220 to be arranged and displayed according to the effects of gravity using the roll and yaw angles obtained by the slope obtaining unit 250 (Configuration Control of Specific Object).

In case that the control unit 230 controls the moving speed, the speed table stored in the memory unit 260 is preferably referred to. In particular, the control unit 230 reads the moving speed from the speed table corresponding to the roll and yaw angles obtained by the slope obtaining unit 250 and outputs a control signal enabling the specific object to move according to the read-in moving speed.

Preferably, the control unit 230 updates contents displayed on the first display unit 210 and the second display unit 220 to correspond to a variation of at least one of the roll and yaw angles. Furthermore, other detailed features of the control methods such as the (1) Moving Direction Control, (2) Moving Speed Control, (3) Simultaneous Control of Moving Direction and Speed and (4) Configuration Control, are equivalent to those for the former mobile communication terminal according to the fourth embodiment of the present invention.

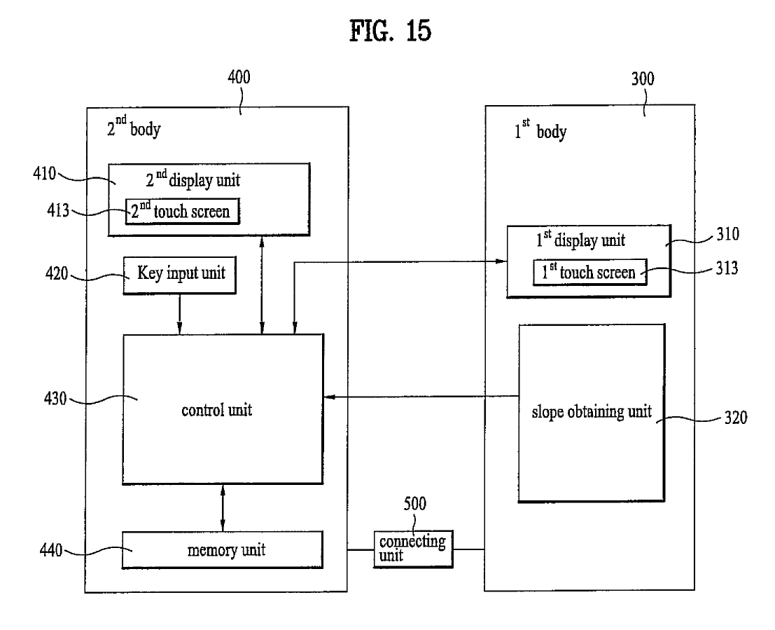

FIG. 15 is a block diagram of a mobile communication terminal in accordance with a sixth embodiment of the present invention. A mobile communication terminal according to the sixth embodiment of the present invention is explained in detail as follows.

Referring to FIG. 15, a mobile communication terminal according to the sixth embodiment of the present invention includes a first body 300, a second body 400 and a connecting unit 500. The first body 300 includes a first display unit 310 and a slope obtaining unit 320. The second body 400 includes a second display unit 410, a key input unit 420, a control unit 430 and a memory unit 440. As shown in FIG. 15, the key input unit 420, the control unit 430 and the memory unit 440 are provided on the second body 400, however, they can be provided on the first body 300. Moreover, the slope obtaining unit 320 can be provided on the second body 400.

For executing basic functions of a mobile communication terminal, the mobile communication terminal according to the sixth embodiment of the present invention includes a mobile communication module (not shown in the drawing) as a communication device for data transmission and reception with a mobile communication network. Notably, the mobile communication module can be provided on the first body 300 or the second body 400.

Basic functions of the above elements are explained as follows. First, the first display unit 310 and the second display unit 410 are display devices for displaying a status of the mobile communication terminal and various kinds of information. The key input unit 420 is an input device provided with various keys including numeral keys and the like to receive various commands from a user.

The mobile communication terminal can further include a touch screen provided as a user interface, separate from the key input unit 420, to at least one of the first display unit 310 and the second display unit 410. In FIG. 15, a reference number 313 indicates a first touch screen and a reference number 413 indicates a second touch screen.

The control unit 430 collectively manages overall operation of the mobile communication terminal. The memory unit 440 stores a prescribed program for controlling the overall operation of the mobile communication terminal. The memory unit 440 also stores data inputted/outputted during execution of the overall operation of the mobile communication terminal by the control unit 430. Furthermore, the memory unit 440 stores various processed data. The memory unit 440 may also store a speed table in which at least one of a roll and yaw angle is matched to a moving speed.

The connecting unit 500 is a device for connecting the first body 300 and the second body 400 together. A terminal type according to a connecting mechanism of the first body 300 and the second body 400 is decided as a folder type, a slide type or a swing type by features of the connecting unit 500.

Meanwhile, the mobile communication terminal according to the sixth embodiment of the present invention can further include a digital broadcast signal receiving unit (not shown in the drawing) for receiving a digital broadcast signal from a broadcasting network. Accordingly, the mobile communication terminal including the mobile communication module and the digital broadcast signal receiving unit is capable of both a communication function and a broadcast receiving function.

The slope obtaining unit 320 obtains a slope of the first body 300 against a ground surface. Preferably, the slope obtaining unit 320 obtains at least one of a roll angle between the first body 300 and the ground surface in a roll axis direction and a yaw angle between the first body 300 and the ground surface in a yaw axis direction. Moreover, the slope obtaining unit 320 can also obtain at least one of the roll and yaw angles using at least one of a gravity detecting sensor, a terrestrial magnetism sensor and an acceleration sensor.

The mobile communication terminal according to the sixth embodiment of the present invention is explained in detail with reference to the operation of the control unit 430 as follows. First, the control unit 430 controls a specific object to be displayed by moving the specific object according to the slope obtained by the slope obtaining unit 320. The control unit 430 also controls the specific object to move between the first display unit 310 and the second display unit 410 as well as within the first display unit 310 or the second display unit 410.

Like the fourth or fifth embodiment of the present invention, in order to implement the display function according to the sixth embodiment of the present invention, the control unit 430 can employ a control method, such as a (1) Moving Direction Control; (2) Moving Speed Control; (3) Simultaneous Control of Moving Direction and Moving Speed; or (4) Configuration Control.

Here, in order to control the specific object displayed on the second display unit 410 to move to according to the effects of gravity, the control unit 430 obtains a relative angle between the first body 300 and the second body 400. As explained for the fourth embodiment of the present invention, because the relative angle configured between the first body 300 and the second body 400 is previously determined in a full open status of the terminal, a slope of the second body 400 against the ground surface can be calculated if a slope of the first body 300 against the ground surface is obtained by the slope obtaining unit 320.

Hence, the control unit 430 is able to control a specific object displayed on the first display unit 310 or the second display unit 410 to move in a direction of gravity using the roll and yaw angles obtained by the slope obtaining unit 320 (Moving Direction Control).

Furthermore, the control unit 430 is able to control a moving speed of a specific object displayed on the first display unit 310 or the second display unit 410 using the roll and yaw angles obtained by the slope obtaining unit 320 (Moving Speed Control of Specific Object).

Also, the control unit 430 is able to simultaneously control a specific object displayed on the first display unit 310 and the second display unit 410 to move in a gravity direction and control a moving speed of the specific object using the roll and yaw angles obtained by the slope obtaining unit 320 (Simultaneous Control of Moving Speed and Direction of Specific Object).

Moreover, the control unit 430 is able to control a specific object displayed on the first display unit 310 and the second display unit 410 to be arranged and displayed according to the effects of gravity using the roll and yaw angles obtained by the slope obtaining unit 320 (Configuration Control of Specific Object).

In case that the control unit 430 controls the moving speed, the speed table stored in the memory unit 440 is preferably referred to. In particular, the control unit 430 reads the moving speed from the speed table corresponding to the roll and yaw angles obtained by the slope obtaining unit 320 and outputs a control signal enabling the specific object to move according to the read-in moving speed.

Preferably, the control unit 430 updates contents displayed on the first display unit 310 and the second display unit 410 to correspond to a variation of at least one of the roll and yaw angles. Furthermore, other detailed features of the control methods, such as the (1) Moving Direction Control, (2) Moving Speed Control, (3) Simultaneous Control of Moving Direction and Speed and (4) Configuration Control are equivalent to those for the former mobile communication terminal according to the fourth embodiment of the present invention.

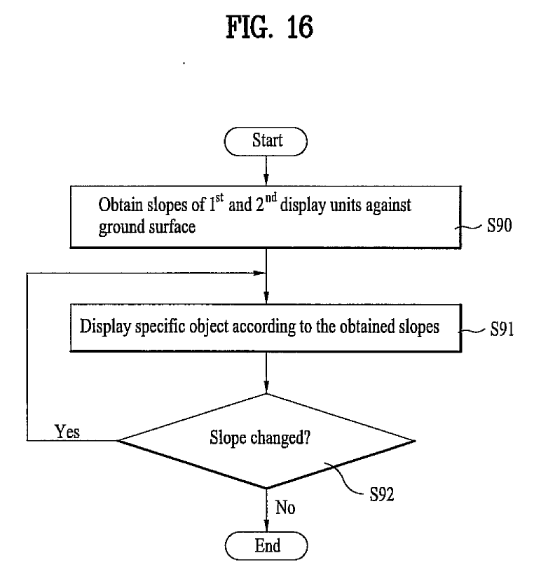

FIG. 16 is a flowchart of a method for displaying an object in accordance with a seventh embodiment of the present invention. A method for displaying an object according to a seventh embodiment of the present invention in a mobile communication terminal having first and second display units is explained in detail as follows.

Referring to FIG. 16, slopes of the first and second display units against a ground surface are obtained, respectively [S90]. The step S90 can be carried out using at least one of a gravity detecting sensor, a terrestrial magnetism sensor and an acceleration sensor. Each of the obtained slopes includes at least one of a first/second roll angle configured by the first/second display unit against the ground surface in a roll axis direction and a first/second yaw angle configured by the first/second display unit against the ground surface in a yaw axis direction.

Meanwhile, the first and second display units can be provided on different bodies, respectively, or can be provided on one body. In case that the first and second display units are provided on different bodies, respectively, detailed features of the slope obtainment of the first and second display units against the ground surface are equivalent to those explained for the fourth or sixth embodiment of the present invention. In case that the first and second display units are provided to one body, detailed features of obtaining the slope of the first and second display units against the ground surface are equivalent to those explained for the fifth embodiment of the present invention.

Subsequently, an object is displayed to move across the first and second display units as well as within the first or second display unit according to the slopes obtained in the step S90 [S91]. Preferably, in the step S91, the object is displayed by varying at least one of a moving direction and speed of the object according to gravity using the obtained slopes. Detailed features of the variations of the moving direction and speed of the object according to the obtained slopes are equivalent to those explained for the fourth embodiment of the present invention.

Subsequently, it is decided whether each of the slopes of the first and second display units against the ground surface are varied [S92]. As a result of the decision made in the step S92, if the slope of the first or second display unit against the ground surface is varied, the step S91 is repeated. In particular, according to the slope variation of the first or second display unit against the ground surface, contents displayed on the first and second display units are updated.

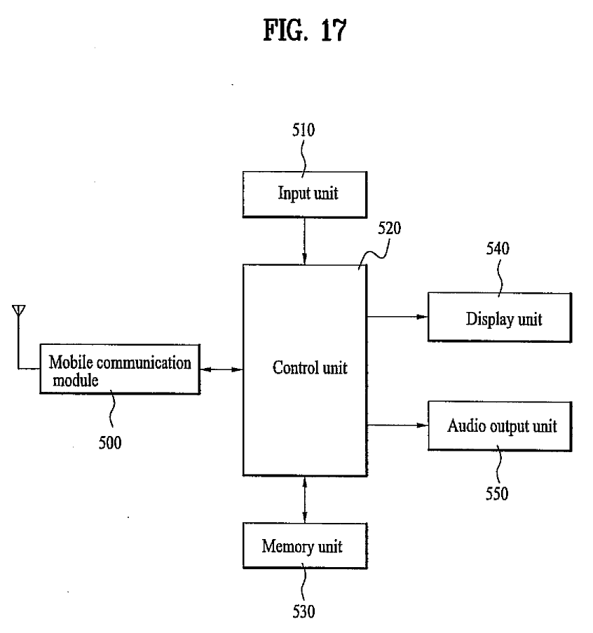

FIG. 17 is a block diagram of a mobile communication terminal in accordance with an eighth embodiment of the present invention. A mobile communication terminal according to the eighth embodiment of the present invention is explained in detail as follows.

Referring to FIG. 17, a mobile communication terminal according to the eighth embodiment of the present invention includes a mobile communication module 500, an input unit 510, a control unit 520, a memory unit 530, a display unit 540 and an audio output unit 550.

Basic functions of the above elements are explained as follows. First, the mobile communication module 500 is a communication device for transmitting/receiving data via a mobile communication network. The input unit 510 is an input device provided with various keys including numeral keys and the like to receive various commands from a user.

The control unit 520 collectively manages overall operation of the mobile communication terminal. The control unit 520 also controls the mobile communication module 500, the input unit 510, the memory unit 530, the display unit 540 and the audio output unit 550.

The memory unit 530 stores a prescribed program for controlling the overall operation of the mobile communication terminal. The memory unit 530 also stores data inputted/outputted during execution of the overall operation of the mobile communication terminal by the control unit 520. Moreover, the memory unit 530 stores various processed data.

The display unit 540 is a display device for displaying a status of the mobile communication terminal and various kinds of information. Similar to the other embodiments of the present invention, a plurality of display units 540 may be provided on the mobile communication terminal. The audio output unit 550 is preferably a device, such as a speaker, for outputting an audio signal and the like.

Preferably, the memory unit 530 stores a plurality of homogeneous or heterogeneous contents that are displayable. The contents include video information displayable on the display unit 540 such as a text, a still picture, animation, a flash and the like. A message sent or received via a short message service (SMS) or a multimedia messaging service (MMS), and displayable on the display unit 540, is included in the contents as well.

The various contents can be classified into various categories according to a prescribed classifying system. For instance, a picture image photographed by a camera may be classified differently from a moving pictures classification.

In the present invention, the control unit 520 detects an occurrence of an event for a status change of the mobile communication terminal. Each time one occurrence of the event is detected, the control unit 520 controls a plurality of contents stored in the memory unit 530 to be displayed. The plurality of contents may be displayed as wall paper on the display unit 540 in a random or predetermined sequence.

The mobile communication terminal according to the eighth embodiment of the present invention shown in FIG. 17 and a method of displaying a wall paper according to a ninth embodiment of the present invention are explained in detail with reference to the operation of the control unit 520 as follows.

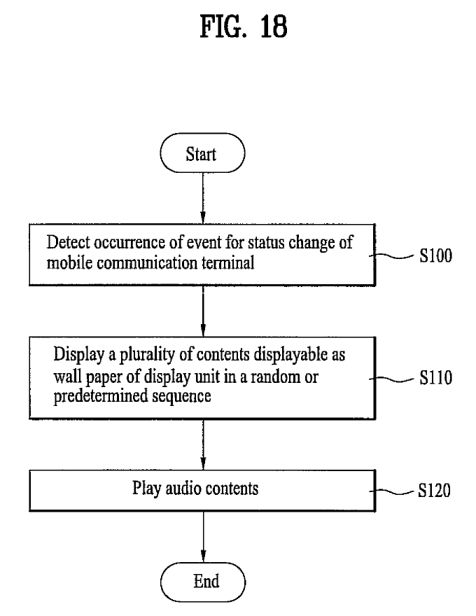

FIG. 18 is a flowchart of a method for displaying a wall paper in accordance with a ninth embodiment of the present invention. Referring to FIG. 18, the control unit 520 detects an occurrence of an event for a status change of the mobile communication terminal [S100]. The event for the status change of the mobile communication terminal includes various status changes of the mobile communication terminal. Examples of the status changes of the mobile communication terminal are explained as follows.

(1) Case that Status of Display Unit Changes

An event can be set to a case that an inactive status of the display unit 540 is changed to an active status. For example, if a folder of a folder type terminal is unfolded, the display unit 540 is activated to display a wall paper. For another example, in a slide type terminal including an upper body and a lower body, the upper body may be pushed upward to activate the display unit 540. For another example, if a touch screen is provided on the display unit 540, then touching a specific point of the touch screen in an idle mode activates the display unit 540.

In yet another example, in order to reduce power consumption, a terminal may provide a function for preventing unnecessary power consumption by switching most of its functions to an inactive status, except for a radio signal receiving function, or turning off the display unit 540, if no input signal is received from a user for a duration of time. If the terminal receives a prescribed input signal from a user, the terminal switches from the inactive status to an active status, or turns on a terminal screen in an off-mode. Preferably, the status change of the display unit 540 from the inactive status to the active status includes all cases that the display unit 540 is activated to perform its intrinsic function. Furthermore, the event of the status change of the display unit 540 to the active status from the inactive status includes a case that the changed active status continues during a prescribed time.

(2) Case of Receiving Input Signal from User

An event can be set to a case that an input signal is received via the input unit 510. For example, a user may press a prescribed key of the input unit 510 to switch an inactive status of the display unit 540 to an active status.

(3) Case of Receiving Radio Signal Externally

An event can be set to a case of receiving a radio signal from a mobile communication network via the mobile communication module 500. For example, an event is set when a call or message is received from the mobile communication network.

(4) Case that Radio Signal Strength Changes

An event can be set to a case when a strength of a radio signal received from a mobile communication network via the mobile communication module 500 reaches a prescribed level. For example, when a mobile communication terminal detects a strength of a downlink radio signal from a mobile communication network, the detected strength of the signal may deviate from a prescribed range to bring about a poor calling status, and therefore trigger the event.

(5) Case that Power Strength Varies

An event can be set to a case when a strength of power supplied by a power supply unit (not shown in the drawing) provided on the terminal reaches a prescribed level. For example, the event may be set when a charged status of a battery supplying power necessary for operating the terminal is changed from a full status to an almost empty status.

Still referring to FIG. 18, after the step S100, the control unit 520 controls a plurality of the homogeneous or heterogeneous displayable contents to be displayed as a wall paper on the display unit 540 in a random or predetermined sequence each time one occurrence of the event is detected [S110]. A plurality of the contents is stored in the memory unit 530, of which detailed features are explained in the foregoing description. Preferably, in case of detecting one occurrence of the event for the status change of the mobile communication terminal, the control unit 520 displays at least two of the contents on the wall paper in a random or predetermined sequence.

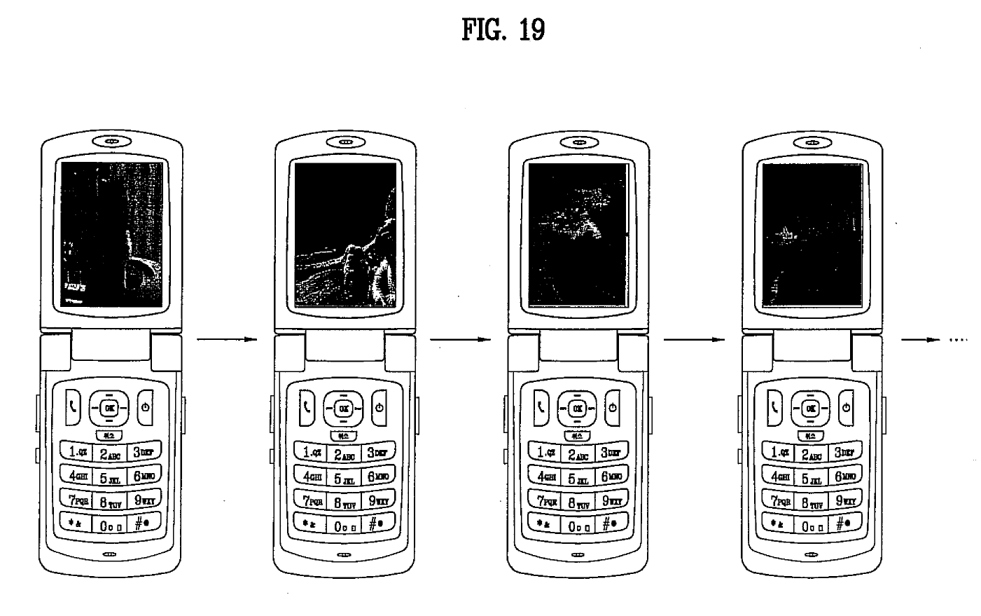

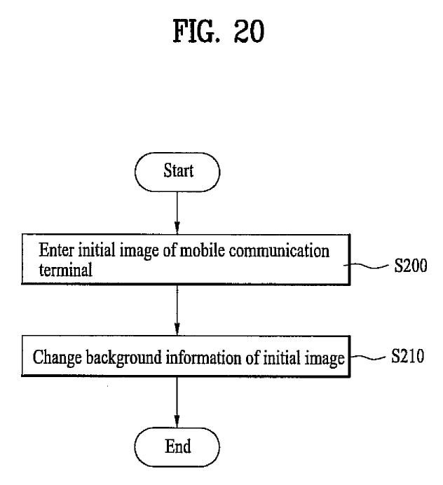

FIG. 19 is a diagram of a plurality of still pictures being displayed as wall paper in accordance with the eighth and ninth embodiments of the present invention. Referring to FIG. 19, if a folder of a folder type mobile communication terminal is unfolded, an event for a status change of the terminal occurs once. Accordingly, a plurality of still pictures, as shown in FIG. 19, are displayed as wall paper of the display unit 540 in a random sequence.

A type, number and display sequence of contents to be displayed as wall paper according to the present invention can be set by a user. An event for displaying a wall paper according to the present invention can be set by the user as well. For example, if an event occurs, such as a status of the display unit 540 changing to an active status from an inactive status, a plurality of images stored in a specific folder of the memory unit 530 can be set to be displayed on the display unit 540 in a random sequence.

Moreover, a speed of displaying a plurality of contents displayed as wall paper can be set by a user. For example, if an event relates to a change of a charged status of a power supply unit, a user can reduce the speed of displaying the plurality of contents as the power supply unit nears a discharged status.

Meanwhile, a status or sequence of the display can be varied according to an occurrence time of the detected event. For example, even if the same event occurs, a type, target and the like of contents to be displayed as a wall paper according to the present invention can be differently set according to whether the occurrence time is in the morning (a.m.) or afternoon (p.m.).

In accordance with the present invention, a display mode of the contents can be set in various ways as follows. First, in displaying a plurality of contents as wall paper, each of a plurality of the contents, as shown in FIG. 3, is displayed individually. Second, a whole or partial portion of a specific one (hereinafter called ‘contents-A’) of a plurality of contents and a whole or partial portion of a next one (hereinafter called ‘contents-B’) of a plurality of the contents are simultaneously displayed during a prescribed time. For example, during the prescribed time, the contents-A becomes dimmer to disappear while the contents-B begins clearer from a dim status.

Referring to FIG. 18, before or after the step S10 or at the same time of the step S110, according to the event occurrence detection in the step S100, the control unit 520 is able to output a control signal to play back audio contents via the audio output unit 550 [S120]. For example, if a specific event occurs, both a wall paper display and playback of a prescribed music file can be set to be performed.

FIG. 20 is a flowchart of a method for changing a background of an initial image in a mobile communication terminal in accordance with a tenth embodiment of the present invention. A method for changing a background of an initial image in a mobile communication terminal according to the tenth embodiment of the present invention is explained as follows. Notably, as a mobile communication terminal that implements a method for changing a background of an initial image according to the tenth embodiment of the present invention, the mobile communication terminal according to the eighth embodiment of the present invention is referred to despite an operational difference of a control unit.

Referring to FIG. 20, an initial image of a mobile communication terminal is entered [S200]. Here, the initial image of the mobile communication terminal indicates an image that is initially displayed if a power of the terminal is turned on in general. However, the initial image of the present invention also includes an image initially displayed if a specific menu or function is entered or if the power of the terminal is turned on.

As an example of the initial image, there is an image displayed on the display unit 540 if the terminal is switched to an active status from an inactive status, an image displayed on the display unit 540 if the terminal receives a signal from a user or mobile communication network, or the like. In this case, the signal received from the user is an input signal and the signal received from the mobile communication network is a radio signal.

Subsequently, each time the initial image is entered, background information of the initial image is changed [S210]. The background information of the initial image includes at least one of a plurality of still pictures, a plurality of moving pictures, a plurality of texts and a plurality of background music. In particular, the background information of the initial image includes video information displayable as a background of the initial image on the display unit 540 or audio information outputted as a background of the initial image via the audio output unit 550.

In the step S210, at least one of a plurality of the still pictures, a plurality of the moving pictures and a plurality of the texts is changed in a random or predetermined sequence. For instance, if a power of a terminal is turned on, a plurality of still pictures, as shown in FIG. 19, are displayed in a random sequence to change the background information of the initial image. Preferably, a change sequence of the background information can be set by a user. Moreover, a change speed of the background information can be set by a user as well.

Meanwhile, in the method of changing the background of the initial image according to the tenth embodiment of the present invention, at least two or more display units can be provided. For instance, first and second display units are provided to offer a user various and sufficient visual information and a multitasking function using the visual information. Furthermore, one video file may be displayed to interoperate between the first and second display units so that a user is provided with a wider screen.

If the mobile communication terminal, in which the method of changing the background of the initial image according to the tenth embodiment of the present invention is implemented, includes a plurality of display units, the initial image may be displayed by interoperating across a plurality of the display units.

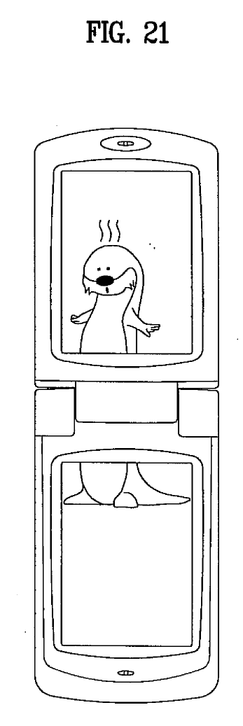

FIG. 21 is a diagram of a displayed initial image interconnected across a pair of display units according to the tenth embodiment of the present invention. Referring to FIG. 21, a display interoperating across a plurality of display units allows a plurality of sub-information, separated from one displayable main information, to be displayed on a plurality of display units, respectively. The information continuity is explained in the aforesaid description of the first embodiment of the present invention. As a representative example, the display, as shown in FIG. 2 or FIG. 3, is conducted interoperable across a plurality of the display units.

It will be apparent to those skilled in the art that various modifications and variations can be made in the present invention without departing from the spirit or scope of the inventions. Thus, it is intended that the present invention covers the modifications and variations of the invention provided they come within the scope of the appended claims and their equivalents.

What is claimed is:

1. A mobile communication terminal capable of displaying information, the mobile communication terminal comprising:
a first display unit for displaying information;
a second display unit for displaying information;
a memory unit for storing displayable main information; and
a control unit for controlling first sub-information of the main information displayable on the first display unit and controlling second sub-information of the main information displayable on the second display unit, wherein the first sub-information and the second sub-information are continually varied and correlated to each other for providing continuity of information between the first display unit and the second display unit.

2. The mobile communication terminal of claim 1, wherein the control unit configures a virtual space for displaying the main information therein, maps the first and second display units to the virtual space, and decides which areas of the main information comprise first and second sub-information by discerning how the mapped first and second display units are respectively overlapped with the main information.

3. The mobile communication terminal of claim 2, further comprising a position detecting unit for detecting a relative position between the first and second display units, wherein the control unit updates the first sub-information and the second sub-information by reflecting a variation of the relative position between the first and second display units on the virtual space.

4. The mobile communication terminal of claim 1, wherein at least one of the first and second display units comprises a touch screen.

5. The mobile communication terminal of claim 4, wherein if a specific point of the touch screen is pressed, the first sub-information and the second sub-information are updated to center on the pressed point.

6. The mobile communication terminal of claim 1, wherein the first sub-information and the second sub-information are updated to center on a randomly moving point on the first and second display units.

7. The mobile communication terminal of claim 1, wherein the main information comprises at least one of a still picture, a moving picture and animation.

8. A method for displaying information in a mobile communication terminal having at least two display units, the method comprising:
extracting at least two sets of sub-information from displayable main information; and
displaying the at least two sets of sub-information on the at least two display units, respectively, wherein the at least two sets of sub-information are continually varied and correlated to each other for providing continuity of information between the at least two display units.

9. The method of claim 8, wherein the main information comprises at least one of a still picture, a moving picture and animation.

10. A method for displaying information in a mobile communication terminal having a first display unit and a second display unit, the method comprising:
configuring a virtual space for displaying main information therein;
mapping the first and second display units to the virtual space;
deciding which areas of the main information comprise first and second sub-information by discerning how the mapped first and second display units are respectively overlapped with the main information; and
displaying the first and second sub-information on the first and second display units, respectively.

11. The method of claim 10, wherein the first and second sub-information are continually varied and correlated to each other for providing continuity of information between the first and second display units.

12. The method of claim 11, wherein if a relative position between the first and second display units is varied, the steps of mapping, deciding and displaying are repeated.

13. The method of claim 10, wherein the main information comprises at least one of a still picture, a moving picture and animation.

14. A mobile communication terminal capable of displaying information, the mobile communication terminal comprising:
a first display unit for displaying information;
a second display unit for displaying information;
a slope obtaining unit for obtaining slopes of the first and second display units with respect to a ground surface, respectively; and
a control unit for controlling a specific object to be displayed by moving the specific object according to the obtained slopes, wherein the specific object is moved across the first and second display units and within the first or second display units.

15. The mobile communication terminal of claim 14, wherein the obtained slopes comprise at least one of first and second roll angles of the first and second display units with respect to the ground surface in a roll axis direction and first and second yaw angles of the first and second display units with respect to the ground surface in a yaw axis direction.

16. The mobile communication terminal of claim 15, wherein the control unit controls at least one of a moving direction and speed of the specific object using the obtained slopes to display the specific object moving across the first and second display units according to gravity.

17. The mobile communication terminal of claim 16, further comprising a memory for storing a speed table in which the moving speed is matched to at least one of a roll and yaw angle, wherein the control unit controls the moving speed of the specific object with reference to the speed table.

18. The mobile communication terminal of claim 16, wherein the control unit updates a display of the specific object on the first and second display units according to variations of the obtained slopes.

19. The mobile communication terminal of claim 14, wherein the slope obtaining unit obtains slopes using at least one a gravity detecting sensor, a terrestrial magnetism sensor and an acceleration sensor.

20. The mobile communication terminal of claim 14, wherein the first and second display units are provided on separate bodies, respectively.

21. The mobile communication terminal of claim 14, wherein the first and second display units are provided on one body.

22. A method for displaying an object in a mobile communication terminal having a first display unit and a second display unit, the method comprising:
obtaining slopes of the first and second display units with respect to a ground surface, respectively; and
controlling the object by moving the specific object according to the obtained slopes, wherein the specific object is moved across the first and second display units and within the first or second display units.

23. A mobile communication terminal capable of displaying information, the mobile communication terminal comprising:
a display unit for displaying information;
a memory for storing a plurality of homogeneous or heterogeneous displayable contents; and
a control unit for detecting an occurrence of an event for a status change of the mobile communication terminal, wherein the control unit controls a plurality of the contents to be displayed as a wall paper on the display unit in a random or predetermined sequence each time the occurrence of the event is detected.

24. The mobile communication terminal of claim 23, wherein the event corresponds to the display unit entering an active status from an inactive status.

25. The mobile communication terminal of claim 23, wherein the event corresponds to an input signal received via an input unit provided on the mobile communication terminal.

26. The mobile communication terminal of claim 23, wherein the event corresponds to a radio signal received from a mobile communication network via a mobile communication module provided on the mobile communication terminal.

27. The mobile communication terminal of claim 23, wherein the event corresponds to a strength of a radio signal received from a mobile communication network via a mobile communication module provided on the mobile communication terminal reaching a prescribed level.

28. The mobile communication terminal of claim 23, wherein the event corresponds to a strength of power supplied from a power supply unit provided on the mobile communication terminal reaching a prescribed level.

29. The mobile communication terminal of claim 23, wherein the control unit varies a display sequence of a plurality of the contents or a type of the contents displayed according to a time of the detected occurrence of the event.

30. The mobile communication terminal of claim 23, wherein the control unit controls a whole or partial portion of a specific one of a plurality of contents (contents A) and a whole or partial portion of a next one of a plurality of contents (contents B) to be simultaneously displayed during a prescribed time.

31. The mobile communication terminal of claim 30, wherein during the prescribed time, the control unit controls the contents A to become dimmer to disappear and the contents B to become clearer from a dim status.

32. The mobile communication terminal of claim 23, wherein the contents include at least one of:
a message received/sent by a short message service (SMS);
a message received/sent by a multimedia messaging service (MMS);
text;
a still picture;
a moving picture; and
animation.

33. The mobile communication terminal of claim 23, further comprising an audio output unit, wherein the memory stores at least one audio content and the control unit controls the at least one audio content to be outputted via the audio output unit according to a detection of the event.

34. A method for displaying a wall paper in a mobile communication terminal, the method comprising:
detecting an occurrence of an event for a status change of the mobile communication terminal; and
controlling a plurality of contents to be displayed as a wall paper on a display unit provided on the mobile communication terminal in a random or predetermined sequence each time the occurrence of the event is detected.

35. The method of claim 34, wherein the event corresponds a radio signal received from a mobile communication network via a mobile communication module provided on the mobile communication terminal.

36. The method of claim 34, wherein in the controlling step, a display sequence of a plurality of contents is varied according to a time of the detected occurrence of the event.

37. The method of claim 34, wherein in the controlling step, a whole or partial portion of a specific one of a plurality of contents (contents A) and a whole or partial portion of a next one of a plurality of contents (contents B) are simultaneously displayed during a prescribed time.

38. The method of claim 37, wherein in the controlling step, during the prescribed time, the contents A becomes dimmer to disappear and the contents B becomes clearer from a dim status.

39. The method of claim 34, wherein the contents include at least one of:
a message received/sent by a short message service (SMS);
a message received/sent by a multimedia messaging service (MMS);
text;
a still picture;
a moving picture; and
animation.

40. The method of claim 341 further comprising playing audio contents according to the detected event.

41. A method for changing a background of an initial image in a mobile communication terminal, the method comprising:
entering the initial image of the mobile communication terminal; and
changing background information of the initial image each time the initial image is entered, wherein the background information comprises at least one of still pictures, a plurality of moving pictures, a plurality of texts and a plurality of background music.
